(19) United States
(12) Patent Application Publication
(10) Pub. No.: US 2025/0096617 A1
(43) Pub. Date: Mar. 20, 2025

(54) WIRELESS CHARGING DEVICE

(71) Applicant: TOYOTA JIDOSHA KABUSHIKI KAISHA, Toyota-shi (JP)

(72) Inventor: Tomohiro IKEDA, Toyokawa-shi (JP)

(73) Assignee: TOYOTA JIDOSHA KABUSHIKI KAISHA, Toyota-shi (JP)

(21) Appl. No.: 18/748,740

(22) Filed: Jun. 20, 2024

(30) Foreign Application Priority Data
Sep. 14, 2023 (JP) 2023-149164

(51) Int. Cl. H02J 50/80; H02J 7/00; H02J 50/10; H02J 50/40

(52) U.S. Cl. CPC H02J 50/80; H02J 7/00034; H02J 7/00045; H02J 7/0044; H02J 50/10; H02J 50/402

(57) ABSTRACT

The wireless charging device is mounted on a vehicle. The wireless charging device includes a control unit. The control unit estimates the moving direction of the mobile terminal on the wireless charging device based on the direction of the acceleration in a case where the occurrence of acceleration having a magnitude equal to or larger than a predetermined threshold in the horizontal direction is detected during charging of the mobile terminal. Further, in the wireless charging device, the control unit determines the position of the power transmitting coil based on the estimated moving direction of the mobile terminal.

### CROSS-REFERENCE TO RELATED APPLICATION

This application claims priority to Japanese Patent Application No. 2023-149164 filed on Sep. 14, 2023, incorporated herein by reference in its entirety.

### BACKGROUND

### 1. Technical Field

The present disclosure relates to a wireless charging device mounted on a vehicle.

### 2. Description of Related Art

Japanese Unexamined Patent Application Publication No. 2021-180578 (JP 2021-180578 A) discloses a contactless charging system. The contactless charging system disclosed in JP 2021-180578 A includes a driving device and a power receiving coil position detection unit. The driving device can move the position of a relay coil. The power receiving coil position detection unit detects or estimates the position of a passive coil relative to a power transmitting coil. The position of the relay coil is controlled by the driving device based on the position of the passive coil relative to the power transmitting coil.

### SUMMARY

An object of the present disclosure is to suppress a decrease in the efficiency of charging of a mobile terminal by a wireless charging device mounted on a vehicle.

A wireless charging device according to the present disclosure is
a wireless charging device to be mounted on a vehicle and configured to charge a placed mobile terminal. The wireless charging device includes a control unit configured to: when an acceleration at a magnitude equal to or larger than a predetermined threshold in a horizontal direction is detected during charging of the mobile terminal, estimate a moving direction of the mobile terminal on the wireless charging device based on the direction of the acceleration; and
determine a position of a power transmitting coil to be energized for charging the mobile terminal on the wireless charging device based on the estimated moving direction of the mobile terminal.

According to the present disclosure, it is possible to suppress the decrease in the efficiency of charging of the mobile terminal by the wireless charging device mounted on the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for explaining an outline of a charging apparatus according to a first embodiment;

FIG. 2 is a block diagram for describing a hardware configuration of a charging device and various devices mounted on a vehicle according to the first embodiment;

FIG. 3 is a flow of energization control according to the first embodiment;

FIG. 4 is a flowchart of a process for acquiring a weight of a mobile terminal according to a modification of the first embodiment; and

FIG. 5 is a flow of energization control according to the second embodiment.

### DETAILED DESCRIPTION OF EMBODIMENTS

Wireless charging devices mounted on vehicles for charging mobile terminals of passengers are known. When the mobile terminal is charged by the wireless charging device, the mobile terminal is placed on the wireless charging device. Then, electric power is generated in the mobile terminal by generating electromagnetic induction by the power transmitting coil provided in the wireless charging device and the power reception coil provided in the mobile terminal, and the battery of the mobile terminal is charged.

However, acceleration occurs during traveling of the vehicle. When acceleration in the horizontal direction occurs while the mobile terminal is being charged by the wireless charging device, the mobile terminal placed on the wireless charging device may move. When the mobile terminal moves on the wireless charging device, there is a possibility that the position of the power receiving coil of the mobile terminal relative to the power transmitting coil of the wireless charging device is shifted. As a result, the amount of electric power generated by the electromagnetic induction in the mobile terminal decreases, and as a result, the charging efficiency of the mobile terminal may decrease. The present disclosure has been made in view of such problems.

The wireless charging device according to the present disclosure is configured to be able to change the position of the power transmitting coil. More specifically, for example, the wireless charging device may include a plurality of power transmitting coils. During charging of the mobile terminal, the position of the power transmitting coil used for charging of the mobile terminal may be changed by changing the power transmitting coil to be energized. In addition, in the wireless charging device, at least one power transmitting coil may be provided to be movable. During charging of the mobile terminal, the position of the power transmitting coil may be changed by moving the power transmitting coil itself during energization.

Further, the wireless charging device according to the present disclosure includes a control unit. Then, when it is detected during charging of the mobile terminal that an acceleration having a magnitude equal to or larger than a predetermined threshold has occurred in the horizontal direction, the control unit estimates the moving direction of the mobile terminal on the wireless charging device based on the direction of the generated acceleration. Here, the predetermined threshold value may be defined as a lower limit value of the magnitude of the acceleration that may cause the mobile terminal to move on the wireless charging device in accordance with the occurrence of the acceleration. According to this configuration, when an acceleration of a magnitude equal to or larger than a predetermined threshold is generated in the vehicle in the horizontal direction during charging of the mobile terminal by the wireless charging device, it can be determined that there is a possibility that the mobile terminal has moved on the wireless charging device.

Further, the control unit determines the position of the power transmitting coil to be energized for charging the mobile terminal in the wireless charging device based on the estimated moving direction of the mobile terminal. That is, the control unit changes the position of the power transmitting coil so as to follow the movement of the mobile terminal on the wireless charging device.

According to this configuration, even if the mobile terminal being charged moves due to the acceleration generated in the traveling vehicle on the wireless charging device, the positional relationship between the power transmitting coil of the wireless charging device and the position of the power reception coil of the mobile terminal can be quickly corrected to an appropriate position. Therefore, it is possible to suppress a decrease in the efficiency of charging of the mobile terminal by the wireless charging device mounted on the vehicle.

Hereinafter, embodiments of the present disclosure will be described below with reference to the drawings. Unless otherwise specified, dimensions, materials, shapes, relative arrangements, and the like of components described in the present embodiments are not intended to limit the technical scope of the present disclosure to those alone.

### First Embodiment

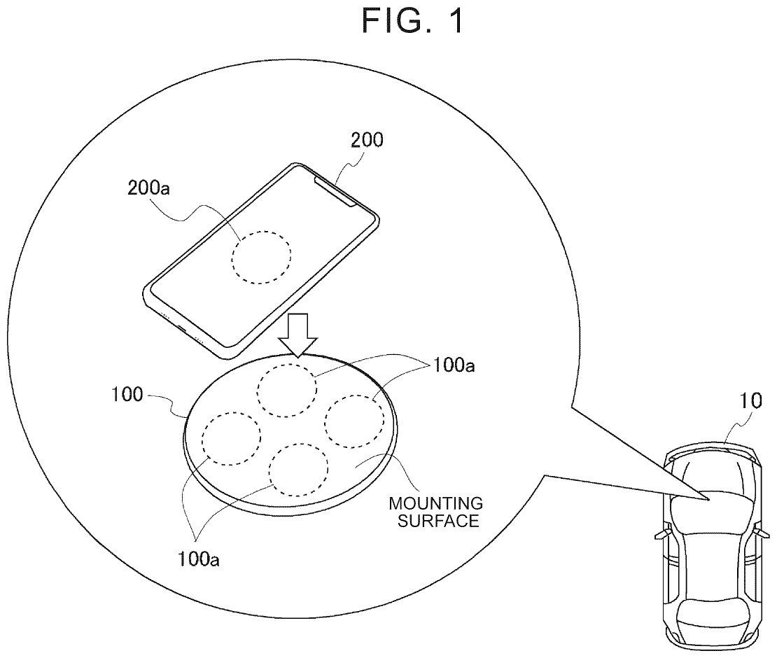

FIG. 1 is a diagram for explaining an outline of a charging apparatus according to the present embodiment. The charging device 100 is a wireless charging device mounted in a vehicle cabin of the vehicle 10. For example, the charging device 100 may be installed in a dashboard or a center console of the vehicle 10. Then, the charging device 100 wirelessly charges the mobile terminal 200 when the mobile terminal 200 possessed by the occupant of the vehicle 10 (the driver of the vehicle 10 or the passenger) is placed on the placing surface of the charging device 100. The mobile terminal 200 may be, for example, a smartphone, a tablet terminal, a wearable terminal, or the like.

The charging device 100 drives the vehicle-mounted battery of the vehicle 10 as a power source. In addition, the charging device 100 charges the mobile terminal 200 by an electromagnetic induction method. Specifically, the mobile terminal 200 includes a power reception coil 200a. On the other hand, the charging device 100 includes a plurality of (four in FIG. 1) power transmitting coil 100a. Then, in the charging device 100, when any one of the plurality of power transmitting coils 100a is energized, electromagnetically induced occurs between the energized power transmitting coil 100a and the power reception coil 200a of the mobile terminal 200. As a result, electric power is generated in the mobile terminal 200, and the battery of the mobile terminal 200 is charged.

Here, in the charging device 100, a plurality of power transmitting coils 100a are provided as described above. Then, the power transmitting coil 100a to be energized is selected from the plurality of power transmitting coils 100a in accordance with the position of the mobile terminal 200 on the mounting surface of the charging device 100. That is, in the charging device 100, the power transmitting coil 100a existing at a position facing the power reception coil 200a of the mobile terminal 200 is selected and energized. As a result, electric power is supplied to the power transmitting coil 100a existing at a position where electromagnetism is likely to occur with the power reception coil 200a of the mobile terminal 200. As a result, the mobile terminal 200 can be efficiently charged.

However, acceleration in the horizontal direction may occur while the vehicle 10 is traveling. When the mobile terminal 200 is placed on the placement surface of the charging device 100, that is, when a certain amount of acceleration occurs in the horizontal direction during charging of the mobile terminal 200, the mobile terminal 200 may move on the placement surface. Consequently, if the relative positional relation between the power transmitting coil 100a energized in the charging device 100 and the power reception coil 200a of the mobile terminal 200 is shifted, the amount of power generated by the mobile terminal 200 may be reduced, and thus the charging efficiency of the mobile terminal 200 may be lowered.

Therefore, in the present embodiment, the charging device 100 changes power transmitting coils 100a to be energized in accordance with the movements of the mobile terminal 200 being charged on the mounting surface. At this time, the charging device 100 estimates the movement amount in the movement direction of the mobile terminal 200 and the movement direction of the mobile terminal 200 based on the direction of the horizontal acceleration generated in the vehicle 10 and the magnitude of the acceleration.

### Hardware Configuration of the Charging Device

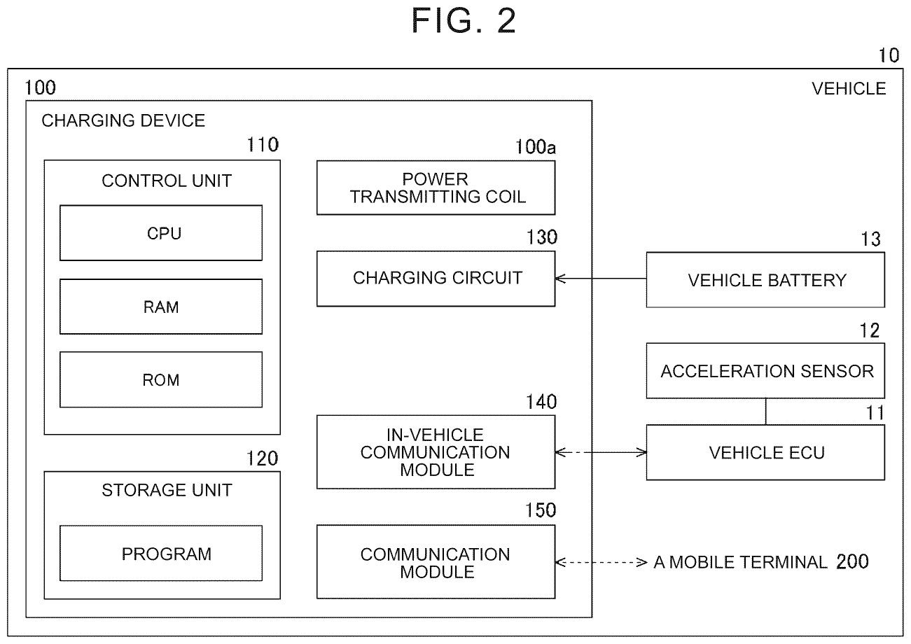

FIG. 2 is a block diagram for describing a hardware configuration of a charging device and various devices mounted in a vehicle according to the present embodiment. The charging device 100 includes a control unit 110, a storage unit 120, a charging circuit 130, an in-vehicle communication module 140, and a communication module 150 in addition to the plurality of power transmitting coil 100a described above.

The vehicle 10 includes a vehicle ECU11, an acceleration sensor 12, and a vehicle battery 13. The vehicle ECU11 is an Electric Central Unit (ECU) for controlling the behavior of the vehicle 10 based on the detected values of various sensors provided in the vehicle 10. The acceleration sensor 12 is a sensor that detects acceleration of the vehicle 10. The acceleration sensor 12 detects acceleration occurring in three axial directions in the X-axis direction, the Y-axis direction, and the Z-axis direction in the vehicle 10. Then, the detected value of the acceleration sensor 12 is inputted to the vehicle ECU11. The vehicle battery 13 is a power source that supplies electric power to various devices provided in the vehicle 10 such as the vehicle ECU11 and the acceleration sensor 12.

The control unit 110 has a function of performing arithmetic processing for controlling the charging device 100. The control unit 110 includes a processor such as Central Processing Unit (CPU), a main storage device such as Random Access Memory (RAM), and a secondary storage device such as Read Only Memory (ROM). CPU is an exemplary processor resource. In addition, RAM and ROM are exemplary memory-resources. The control unit 110 can execute arbitrary information processing based on various programs and various data. However, some or all of the functions of the control unit 110 may be realized by a hardware-circuit such as a ASIC, FPGA. The storage unit 120 is constituted by any storage device such as a RAM, ROM, or a flash memory. The storage unit 120 stores programs to be executed by the control unit 110 and various types of data to be used for executing the programs.

The charging circuit 130 converts DC power supplied from the vehicle battery 13 into AC power having an appropriate amplitude and frequency. The charging circuit 130, which is a circuit for supplying the converted AC power to the power transmitting coil 100a to be energized, includes, for example, DC-DC converters, inverters, and the like.

The in-vehicle communication module 140 is an interface for the charging device 100 to communicate with other devices provided in the vehicle 10 using a predetermined in-vehicle communication standard. Examples of the predetermined in-vehicle communication standard include Controller Area Network (CAN) and Local Interconnect Network (LIN). The charging device 100 communicates with the vehicle ECU11 via the in-vehicle communication module 140. For example, the charging device 100 periodically receives, from the vehicle ECU11, information on the direction and magnitude of the horizontal acceleration generated in the vehicle 10, which is calculated by the vehicle ECU1l based on the detected value of the acceleration sensor 12, at a predetermined cycle.

The communication module 150 is an interface for the charging device 100 to directly communicate with the mobile terminal 200 placed on the placement surface using a predetermined short-range wireless communication standard. Examples of the predetermined short-range radio communication standard include Bluetooth (registered trademark) Low Energy standard and WiFi (registered trademark). The charging device 100 communicates with the mobile terminal 200 being charged via the communication module 150. For example, the charging device 100 periodically receives the status of the mobile terminal 200 including the electric power (generation amount) generated by the electromagnetic induction in the mobile terminal 200 from the mobile terminal 200 at a predetermined cycle.

The mobile terminal 200 includes a processor such as a Central Processing Unit (CPU), a main storage device such as a Random Access Memory (RAM), and a secondary storage device such as a Read Only Memory (ROM). Further, the mobile terminal 200 includes a communication module that uses a standard similar to the near field wireless communication standard used by the communication module 150 of the charging device 100.

### Flow of Energization Control

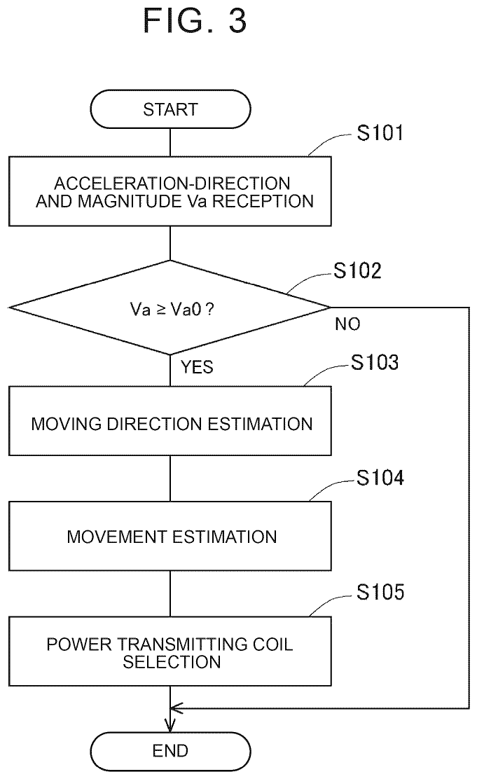

Next, a flow of energization control executed in the charging device 100 will be described with reference to FIG. 3. FIG. 3 is a flow of energization control according to the present embodiment. This flow is executed by the control unit 110 when the mobile terminal 200 is placed on the placement surface of the charging device 100, that is, during charging of the mobile terminal 200 by the charging device 100.

In this flow, first, in S101, the direction and magnitude Va of the lateral acceleration generated in the vehicle 10, which is transmitted from the vehicle ECU11, is received. Next, in S102, it is determined whether or not the magnitude Va of the acceleration received by S101 (that is, the absolute value of the acceleration) is equal to or greater than a predetermined threshold Va0. Here, the predetermined threshold Va0 may be determined as the lower limit of the magnitude of the acceleration at which the mobile terminal 200 may move on the charging device 100 in accordance with the generation of the acceleration. Note that the charging device 100 may be provided with an acceleration sensor capable of detecting the direction and magnitude of acceleration in the horizontal direction. In this case, the charging device 100 can recognize the accelerations generated in the vehicle 10 without communicating with the vehicle ECU11.

When a negative determination is made in S102, that is, when the magnitude Va of the acceleration is less than the predetermined threshold Va0, it can be assumed that the mobile terminal 200 is not moving on the charging device 100. In this case, the execution of this flow is once terminated.

On the other hand, when an affirmative determination is made on S102, that is, when the magnitude Va of the acceleration is equal to or larger than a predetermined threshold Va0, it can be assumed that the mobile terminal 200 has moved on the charging device 100. Then, S103 process is executed next. In S103, the moving direction of the mobile terminal 200 on the charging device 100 is estimated based on the direction of the accelerations received by S101.

Next, in S104, the travel distance of the mobile terminal 200 on the charging device 100 is estimated based on the magnitude of the accelerations received by S101. Here, it is estimated that the larger the magnitude of the acceleration received by S101 is, the larger the moving distance of the mobile terminal 200 on the charging device 100 is.

Next, in S105, the power transmitting coil 100a to be energized among the plurality of power transmitting coils 100a is selected based on the moving direction of the mobile terminal 200 and the moving amount of the mobile terminal 200 estimated by S103. At this time, when it is determined that the power transmitting coil 100a existing at the position opposite to the power reception coil 200a of the mobile terminal 200 has a power transmitting coil 100a that differs from the power transmitting coil 100a prior to the acceleration generation due to the movement of the mobile terminal 200, the power transmitting coil 100a to be energized is changed. On the other hand, even after the mobile terminal 200 has moved, if the power transmitting coil 100a existing at the position opposite to the power reception coil 200a of the mobile terminal 200 is the same as that prior to the acceleration-generation, energization to the same power transmitting coil 100a is continued. After that, the execution of this flow is once terminated.

According to the above-described flowchart, it is possible to quickly correct the power transmitting coil 100a to be energized to an appropriate coil even when the position of the power reception coil 200a of the mobile terminal 200 with respect to the power transmitting coil 100a that has been energized in the charging device 100 is shifted due to the acceleration occurring in the vehicle 10. That is, the position of the power transmitting coil 100a to be energized for charging the mobile terminal 200 in the charging device 100 can be quickly changed so as to follow the moving of the mobile terminal 200. Therefore, it is possible to suppress a decrease in the efficiency of charging of the mobile terminal 200 by the charging device 100.

### Modified Examples

Next, a modification of the present embodiment will be described. As described above, when a certain amount of acceleration is generated in the horizontal direction in the vehicle 10 during charging of the mobile terminal 200, the mobile terminal 200 may move on the charging device 100. At this time, even if the magnitudes of the accelerations are the same, the amount of movement of the mobile terminal 200 may change according to the weight of the mobile terminal 200. Therefore, in the present modification, the control unit 110 of the charging device 100 estimates the amount of movement of the mobile terminal 200 on the charging device 100 based on not only the magnitude of the acceleration in the horizontal direction but also the weight of the mobile terminal 200.

More specifically, in the present modification, a database (hereinafter, referred to as a “mobile terminal database”) in which information on the weight of each model of the mobile terminal that can be a charging target is input is stored in the storage unit 120 of the charging device 100. In addition, model information indicating the model of the mobile terminal 200 placed on the charging device 100 is transmitted from the mobile terminal 200 to the charging device 100. Then, when the mobile terminal 200 is placed on the charging device 100, the control unit 110 executes a process for acquiring the weight of the mobile terminal 200.

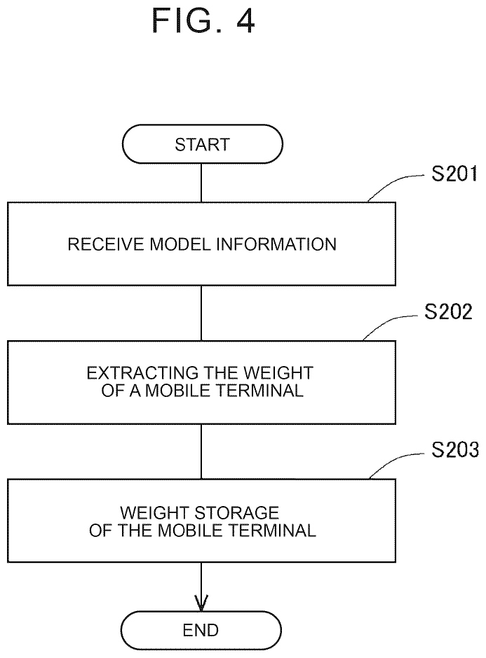

FIG. 4 is a flow of processing for acquiring the weight of the mobile terminal according to the present modification. This flow is executed by the control unit 110 at a timing when the mobile terminal 200 is placed on the placement surface of the charging device 100.

First, in S201, model data of the mobile terminal 200 transmitted from the mobile terminal 200 is received. Next, in S202, the weight of the mobile terminal 200 corresponding to the model data received by S201 is extracted from the mobile terminal data base. Next, in S203, the weight of the mobile terminal 200 currently placed on the charging device 100 extracted by S202 is stored in the storage unit 120. After that, the execution of this flow is once terminated. The weight of the mobile terminal 200 stored in the storage unit 120 is deleted from the storage unit 120 when the mobile terminal 200 is taken up from the charging device 100.

In the present modification, when the control unit 110 executes S104 process of the energization control shown in FIG. 3, the weight of the mobile terminal 200 is acquired from the storage unit 120. Then, the control unit 110 estimates the movement amount of the mobile terminal 200 based on the magnitude of the acceleration in the horizontal direction and the weight of the mobile terminal 200.

According to this modification, it is possible to estimate the movement amount when the mobile terminal 200 moves on the charging device 100 due to the occurrence of the acceleration in the horizontal direction in the vehicle 10 with higher accuracy. Therefore, the power transmitting coil 100a to be energized can be selected more appropriately.

### Second Embodiment

Also in the present embodiment, the configurations of the charging device 100 and the mobile terminal 200 are the same as those of the first embodiment. Also in the present embodiment, when acceleration in the horizontal direction occurs in the vehicle 10 during charging of the mobile terminal 200, the moving direction of the mobile terminal 200 and the moving amount of the mobile terminal 200 are estimated. Then, the electric power transmitting coil 100a to be energized among the plurality of electric power transmitting coil 100a is selected in the charging device 100 based on the estimated moving direction of the mobile terminal 200 and the moving amount of the mobile terminal 200. However, in the present embodiment, in a case where acceleration in the horizontal direction occurs in the vehicle 10 during charging of the mobile terminal 200, unlike the first embodiment, the amount of movement of the mobile terminal 200 is estimated based on the amount of change in the amount of power generation in the mobile terminal 200.

More specifically, during charging of the mobile terminal 200, the charging device 100 periodically receives information related to the amount of power generated by the mobile terminal 200 at a predetermined cycle. When an acceleration of a magnitude equal to or larger than a predetermined threshold Va0 is generated horizontally in the vehicle 10 during charging of the mobile terminal 200, the control unit 110 of the charging device 100 calculates a change amount before and after the generation of the acceleration of the power generation amount in the mobile terminal 200 during charging.

Further, as described above, when the relative positional relation between the power transmitting coil 100a energized in the charging device 100 and the power reception coil 200a of the mobile terminal 200 is shifted during charging of the mobile terminal 200, the power generation quantity in the mobile terminal 200 is reduced. At this time, for example, when the position of the power reception coil 200a with respect to the power transmitting coil 100a to which electric power is supplied is the position at which the amount of electric power generated by the mobile terminal 200 is maximized, the amount of reduction in the amount of electric power generated by the mobile terminal 200 is larger as the amount of displacement of the relative positional relation between the two coils 100a, 200a after the acceleration is generated is larger. Therefore, the amount of movement of the mobile terminal 200 can be calculated based on the amount of change before and after the generation of the acceleration of the power generation amount in the mobile terminal 200.

### Flow of Energization Control

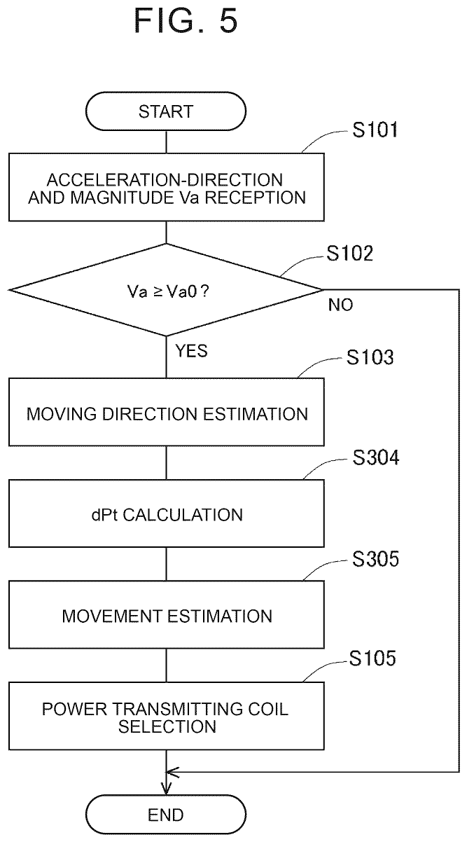

Hereinafter, a flow of energization control executed in the charging device 100 according to the present embodiment will be described with reference to FIG. 5. FIG. 5 is a flow of energization control according to the present embodiment. This flow is executed by the control unit 110 when the mobile terminal 200 is placed on the placement surface of the charging device 100, that is, during charging of the mobile terminal 200 by the charging device 100. In this flow, S104 of the flow of the energization control according to the first embodiment shown in FIG. 3 is replaced with S304 and S305. Therefore, the processing in S304 and S305 will be described below, and the description of the processing in the rest of the steps will be omitted.

In this process, S304 process is executed after S103. In S103, the change amount dPt of the power generation amount in the mobile terminal 200 before and after the generation of the acceleration of the magnitude equal to or larger than the predetermined threshold Va0 is calculated. At this time, the control unit 110 calculates a change amount dPt of the power generation amount from the power generation amount received from the mobile terminal 200 immediately before the acceleration generation and the power generation amount received from the mobile terminal 200 immediately after the acceleration generation.

Next, in S305, the moving amount of the mobile terminal 200 on the charging device 100 is estimated based on the change amount dPt of the power generation amount in the mobile terminal 200 calculated by S304. Here, it is estimated that the amount of movement of the mobile terminal 200 on the charging device 100 is larger as the amount of decrease in the amount of power generation in the mobile terminal 200 is larger. After S305, S105 process is executed.

Also in the present embodiment, the magnitude Va of the horizontal-direction accelerations generated in the vehicles 10 is received by S101. Therefore, the control unit 110 may estimate the moving amount of the mobile terminal 200 on the charging device 100 based on the magnitude Va of the acceleration and the change amount dPt of the power generation amount in the mobile terminal 200.

The position of the power reception coil 200a of the mobile terminal 200 with respect to the power transmitting coil 100a that has been energized by the charging device 100 may be displaced due to the generation of accelerations in the vehicles 10. Even in such cases, the power transmitting coil 100a to be energized can be quickly corrected to an appropriate coil.

In the first embodiment and the second embodiment, the charging device 100 includes a plurality of power transmitting coils 100a. Then, in the charging device 100, the position of the power transmitting coil 100a used for charging the mobile terminal 200 is changed by changing the power transmitting coil 100a to be supplied. However, the configuration of the charging device according to the present disclosure is not limited to the configuration including the plurality of power transmitting coils. For example, as the configuration of the charging device 100, a configuration having one power transmitting coil 100a configured to be movable in the charging device 100 may be employed. In the charging device 100, the control unit 110 controls the position of the power transmitting coil 100a by moving the power transmitting coil 10a themselves. In this situation, the position of the power transmitting coil 100a used to charge the mobile terminal 200 is changed by changing the position of the power transmitting coil 100a being energized.

### Other Embodiments

The above-described embodiments are merely examples, and the present disclosure may be appropriately modified and implemented without departing from the scope thereof. For example, the processes and means described in the present disclosure can be free combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc read-only memory (CD-ROM), digital versatile disc (DVD), Blu-ray disc, etc.), a read-only memory (ROM), a random access memory (RAM), an erasable programmable read-only memory (EPROM), an electrically erasable programmable read only memory (EEPROM), a magnetic card, a flash memory, or any type of medium suitable for storing electronic commands such as an optical card.

What is claimed is:

1. A wireless charging device to be mounted on a vehicle and configured to charge a placed mobile terminal, the wireless charging device comprising a control unit configured to:
when an acceleration at a magnitude equal to or larger than a predetermined threshold in a horizontal direction is detected during charging of the mobile terminal, estimate a moving direction of the mobile terminal on the wireless charging device based on the direction of the acceleration; and
determine a position of a power transmitting coil to be energized for charging the mobile terminal on the wireless charging device based on the estimated moving direction of the mobile terminal.

2. The wireless charging device according to claim 1, wherein:
the control unit is further configured to, when the acceleration at the magnitude equal to or larger than the predetermined threshold in the horizontal direction is detected during the charging of the mobile terminal, estimate a moving amount of the mobile terminal on the wireless charging device based on the magnitude of the acceleration; and
the control unit is configured to determine the position of the power transmitting coil based on the estimated moving direction of the mobile terminal and the estimated moving amount of the mobile terminal.

3. The wireless charging device according to claim 2, wherein:
the control unit is further configured to acquire a weight of the mobile terminal during the charging; and
the control unit is configured to estimate the moving amount of the mobile terminal on the wireless charging device based on the magnitude of the acceleration and the weight of the mobile terminal.

4. The wireless charging device according to claim 3, wherein:
the control unit is further configured to receive model information of the mobile terminal from the mobile terminal during the charging; and
the control unit is configured to acquire the weight of the mobile terminal corresponding to the received model information of the mobile terminal.

5. The wireless charging device according to claim 1, wherein:
the control unit is further configured to, when the acceleration at the magnitude equal to or larger than the predetermined threshold in the horizontal direction is detected during the charging of the mobile terminal, estimate a moving amount of the mobile terminal on the wireless charging device based on an amount of change before and after generation of the acceleration in terms of a power generation amount in the mobile terminal during the charging; and
the control unit is configured to determine the position of the power transmitting coil based on the estimated moving direction of the mobile terminal and the estimated moving amount of the mobile terminal.
